(19) United States
(12) Patent Application Publication
(10) Pub. No.: US 2017/0364400 A1
(43) Pub. Date: Dec. 21, 2017

(54) METHOD FOR DEBUGGING STATIC MEMORY CORRUPTION

(71) Applicant: International Business Machines Corporation, Armonk, NY (US)

(72) Inventors: Jia He, Shanghai (CN); Zhong Li, Shanghai (CN)

(21) Appl. No.: 15/182,727

(22) Filed: Jun. 15, 2016

(51) Int. Cl. G06F 11/07; G06F 11/16; G06F 12/1009; G06F 12/128

(52) U.S. Cl. CPC G06F 11/079; G06F 12/128; G06F 11/167; G06F 12/1009

(57) ABSTRACT

An indication is received. The indication is of an address in a first page in virtual memory used by an application with a static memory corruption. A loadable kernel module will monitor the address. Access to the first page in virtual memory is changed from read/write access to read only access. A second page in virtual memory is created with read/write access. Whether a page fault occurs on the first page in virtual memory during the execution of the application with the static memory corruption is determined.

### BACKGROUND

The present invention relates generally to the field of static memory, and more particularly to debugging a static memory corruption.

In computing, memory refers to the computer hardware devices used to store information for immediate use in a computer and it is synonymous with the term “primary storage”. Computer memory operates at a high speed, for example random-access memory (RAM), as a distinction from storage that provides slow-to-access program and data storage but offers higher capacities. If needed, contents of the computer memory can be transferred to secondary storage, through a memory management technique called “virtual memory”. An archaic synonym for memory is “store”.

The term “memory”, meaning “primary storage” or “main memory”, is often associated with addressable semiconductor memory, (i.e., integrated circuits consisting of silicon-based transistors, used for example as primary storage but also other purposes in computers and other digital electronic devices). There are two main kinds of semiconductor memory, volatile and non-volatile. Volatile (i.e., static) memory is computer memory that requires power to maintain the stored information. Volatile memory retains its contents while powered on but when the power is interrupted, the stored data is lost very rapidly or immediately. Non-volatile memory is a type of computer memory that can retrieve stored information even after having been power cycled (i.e., turned off and back on). Typical secondary storage devices are hard disk drives and solid-state drives.

### SUMMARY OF THE INVENTION

Embodiments of the present invention include a method, computer program product, and system for debugging a static memory corruption. In one embodiment, an indication is received. The indication is of an address in a first page in virtual memory used by an application with a static memory corruption. A loadable kernel module will monitor the address. Access to the first page in virtual memory is changed from read/write access to read only access. A second page in virtual memory is created with read/write access. Whether a page fault occurs on the first page in virtual memory during the execution of the application with the static memory corruption is determined.

### BRIEF DESCRIPTION OF THE DRAWINGS

FIG. 1 depicts a functional block diagram of a computing environment, in accordance with an embodiment of the present invention;

FIG. 2 depicts a flowchart of operational steps of a program for debugging a static memory corruption, in accordance with an embodiment of the present invention;

FIG. 3 is a detailed example of the computing environment of FIG. 1; and

FIG. 4 depicts a block diagram of components of the computing environment of FIG. 1, in accordance with an embodiment of the present invention.

### DETAILED DESCRIPTION

Embodiments of the present invention provide for debugging a static memory corruption. One type of memory corruption occurs when a program attempts to read or write to an area of memory where the program does not have read/write access. This type of memory corruption will result in a write access page fault. Another type of memory corruption when the wrong data is saved to a particular location in memory. The program code has write access to the particular memory location but writing to the location is an illegal operation from the perspective of the program. For example, a particular area of memory may be set upon initialization of the program and then not changed afterwards. The program may have write access to this area but any attempt to write data in the area is an illegal operation. The difficulty in debugging the memory corruption is determining what program step changed the memory and how the memory was modified. One method of debugging requires the use of debug code, which is computer code introduced to a computer program. However, customers using the program with the memory corruption may not want to modify the actual code of the program.

Embodiments of the present invention recognize that there may be a method, computer program product, and computer system for debugging a static memory corruption. The method, computer program product, and computer system may use a loadable kernel module (LKM) to monitor virtual memory for an illegal operation, which is a write access to an area in the virtual memory that violates a pre-defined rule for the virtual memory. In conjunction with the LKM, a debug program may be used to input a set of rules to the LKM and to capture relevant data concerning the state of an application or program when the illegal operation occurs. Neither the LKM nor the debug program require modification of the program code of the program with the memory corruption.

The present invention will now be described in detail with reference to the Figures.

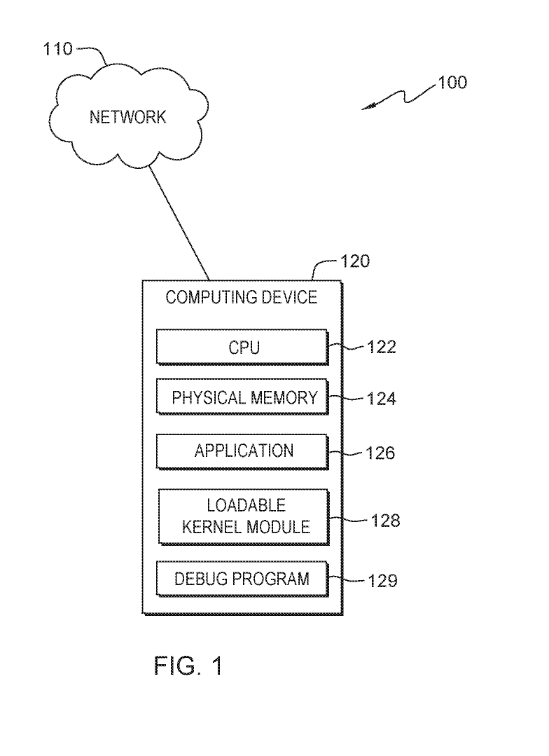

FIG. 1 is a functional block diagram illustrating a computing environment, generally designated 100, in accordance with one embodiment of the present invention. FIG. 1 provides only an illustration of one implementation and does not imply any limitations with regard to the systems and environments in which different embodiments may be implemented. Many modifications to the depicted embodiment may be made by those skilled in the art without departing from the scope of the invention as recited by the claims.

In an embodiment, computing environment 100 includes computing device 120 connected to network 110. In example embodiments, computing environment 100 may include other computing devices (not shown) such as smartwatches, cell phones, smartphones, wearable technology, phablets, tablet computers, laptop computers, desktop computers, other computer servers or any other computer system known in the art, interconnected with computing device 120 over network 110.

In example embodiments, computing device 120 may connect to network 110, which enables computing device 120 to access other computing devices and/or data not directly stored on computing device 120. Network 110 may be, for example, a local area network (LAN), a telecommunications network, a wide area network (WAN) such as the Internet, or any combination of the three, and include wired, wireless, or fiber optic connections. Network 110 may include one or more wired and/or wireless networks that are capable of receiving and transmitting data, voice, and/or video signals, including multimedia signals that include voice, data, and video information. In general, network 110 can be any combination of connections and protocols that will support communications between computing device 120 and any other computing device connected to network 110, in accordance with embodiments of the present invention. In an embodiment, data received by another computing device in computing environment 100 (not shown) may be communicated to computing device 120 via network 110.

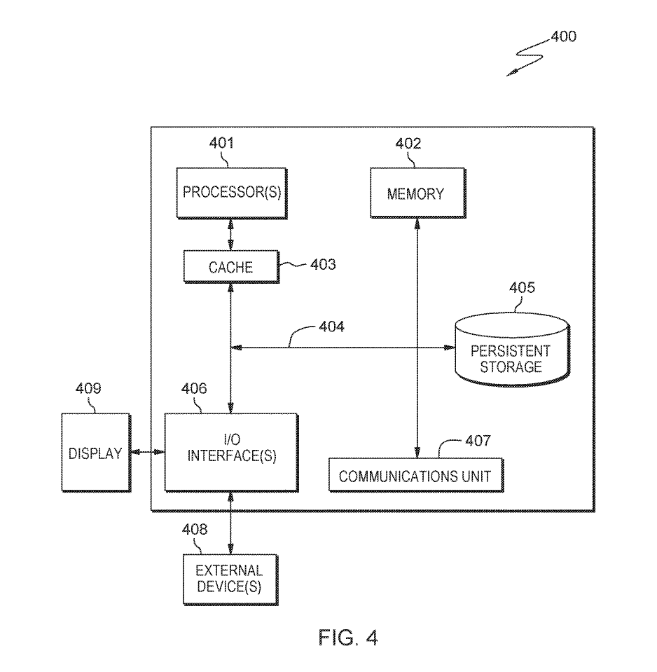

In an embodiment, computing device 120 includes central processing unit (CPU) 122, physical memory 124, application 126, loadable kernel module (LKM) 128, and debug program 129. In embodiments of the present invention, computing device 120 may be a laptop, tablet, or netbook personal computer (PC), a desktop computer, a personal digital assistant (PDA), a smartphone, a standard cell phone, a smart-watch or any other wearable technology, or any other hand-held, programmable electronic device capable of communicating with any other computing device within computing environment 100. In certain embodiments, computing device 120 represents a computer system utilizing clustered computers and components (e.g., database server computers, application server computers, etc.) that act as a single pool of seamless resources when accessed by elements of computing environment 100. In general, computing device 120 is representative of any electronic device or combination of electronic devices capable of executing computer readable program instructions. Computing environment 100 may include any number of computing device 120. Computing device 120 may include components as depicted and described in further detail with respect to FIG. 4, in accordance with embodiments of the present invention.

According to embodiments of the present invention, CPU 122 is the electronic circuitry within a computer that carries out the instructions of a computer program by performing the basic arithmetic, logical, control, and input/output (110) operations specified by the instructions. The term “CPU” refers to a processor, more specifically to its processing unit and control unit (CU), distinguishing these core elements of a computer from external components such as memory and 110 circuitry. Principal components of a CPU include the arithmetic logic unit (ALU) that performs arithmetic and logic operations, processor registers that supply operands to the ALU and store the results of ALU operations, and a control unit that fetches instructions from memory and “executes” them by directing the coordinated operations of the ALU, registers and other components. Modern CPUs are microprocessors, meaning they are contained on a single integrated circuit (IC) chip. An IC that contains a CPU may also contain memory, peripheral interfaces, and other components of a computer. Such integrated devices are variously called microcontrollers or systems on a chip (SoC). Some computers employ a multi-core processor, which is a single chip containing two or more CPUs called “cores”. In that context, single chips are sometimes referred to as “sockets”. Array processors or vector processors have multiple processors that operate in parallel, with no unit considered central.

According to embodiments of the present invention, physical memory 124 may be storage that may be written to and/or read by computing device 120. In one embodiment, physical memory 124 resides on computing device 120. In other embodiments, physical memory 124 may reside on any other device (not shown) in computing environment 100, in cloud storage or on another computing device accessible via network 110. In yet another embodiment, physical memory 124 may represent multiple storage devices within computing device 120. In an embodiment, physical memory 124 may be managed by debug program 129. In an alternative embodiment, physical memory 124 may be managed by the operating system of computing device 120, alone, or together with, debug program 129. Physical memory 124 may be implemented using any volatile or non-volatile storage media for storing information, as known in the art. For example, physical memory 124 may be implemented with a tape library, optical library, one or more independent hard disk drives, multiple hard disk drives in a redundant array of independent disks (RAID), solid-state drives (SSD), or random-access memory (RAM). Similarly, physical memory 124 may be implemented with any suitable storage architecture known in the art, such as a relational database, an object-oriented database, or one or more tables. In an embodiment of the present invention, application 126, debug program 129, and any other programs and applications (not shown) operating on computing device 120 may store data to physical memory 124.

According to embodiments of the present invention, application 126 may be a program, subprogram of a larger program, application, plurality of applications, or mobile application software that performs a function. A program is a sequence of instructions written by a programmer to perform a specific task. Application 126 may run by itself but may be dependent on system software (not shown) to execute. In one embodiment, application 126 functions as a stand-alone program residing on computing device 120. In another embodiment, application 126 may be included as a part of an operating system (not shown) of computing device 120. In yet another embodiment, application 126 may work in conjunction with other programs, applications, etc., found on computing device 120 or in computing environment 100. In yet another embodiment, application 126 may be found on other computing devices (not shown) in computing environment 100 which are interconnected to computing device 120 via network 110. In an embodiment, application 126 includes a memory corruption. In an embodiment, a memory corruption occurs in a computer program when the contents of a memory location are unintentionally modified due to programming errors. When the corrupted memory contents are used later in that program, it leads either to program crash or to strange and bizarre program behavior.

In an embodiment, LKM 128 is an object file that contains code to extend the running kernel, or base kernel, of an operating system (OS). LKMs may be used to add support for new hardware (e.g., device drivers) and/or file systems, or for adding system calls. When the functionality provided by a LKM is no longer required, it can be unloaded in order to free memory and other resources. In an embodiment, LKM 128 is added to the OS of computing device 120 to monitor a specified area of virtual memory (not shown).

According to embodiments of the present invention, debug program 129 may be a program, subprogram of a larger program, application, plurality of applications, or mobile application software that functions to debug a static memory corruption. A program is a sequence of instructions written by a programmer to perform a specific task. Debug program 129 may run by itself but may be dependent on system software (not shown) to execute. In one embodiment, debug program 129 functions as a stand-alone program residing on computing device 120. In another embodiment, debug program 129 may be included as a part of an operating system (not shown) of computing device 120. In yet another embodiment, debug program 129 may work in conjunction with other programs, applications, etc., found on computing device 120 or in computing environment 100. In yet another embodiment, debug program 129 may be found on other computing devices (not shown) in computing environment 100 which are interconnected to computing device 120 via network 110.

In an embodiment, computing device 120 may include a user interface (not shown) that allows a user to interact with debug program 129. A user interface is a program that provides an interface between a user and other programs on computing device 120. A user interface refers to the information (such as graphic, text, and sound) a program presents to a user and the control sequences the user employs to control the program. There are many types of user interfaces. In one embodiment, the user interface can be a graphical user interface (GUI). A GUI is a type of user interface that allows users to interact with electronic devices, such as a keyboard and mouse, through graphical icons and visual indicators, such as secondary notations, as opposed to text-based interfaces, typed command labels, or text navigation. In computers, GUIs were introduced in reaction to the perceived steep learning curve of command-line interfaces, which required commands to be typed on the keyboard. The actions in GUIs are often performed through direct manipulation of the graphics elements.

According to embodiments of the present invention, debug program 129 functions to debug a static memory corruption. According to an embodiment of the present invention, a user may use debug program 129, via the user interface previously discussed, to input rules and a virtual memory location to LKM 128, in order to debug an application with a memory corruption.

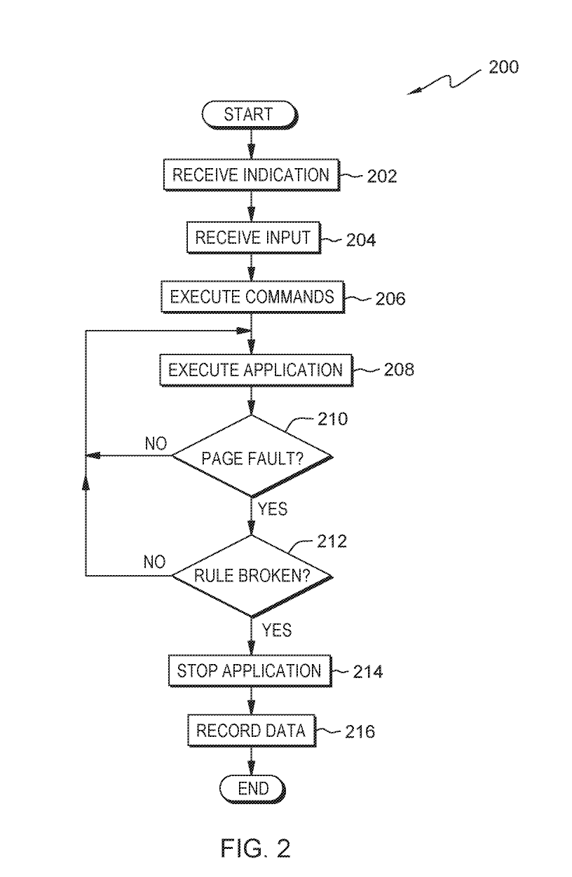

FIG. 2 is a flowchart of workflow 200 depicting operational steps for debugging a static memory corruption, in accordance with an embodiment of the present invention. In one embodiment, the steps of workflow 200 are performed by debug program 129. In an alternative embodiment, the steps of workflow 200 may be performed by any other program working with debug program 129. In an embodiment, a user, via a user interface previously discussed, may invoke workflow 200 upon a user loading LKM 128 onto a computing device. In an alternative embodiment, a user, via a user interface discussed previously, may invoke workflow 200 upon opening debug program 129.

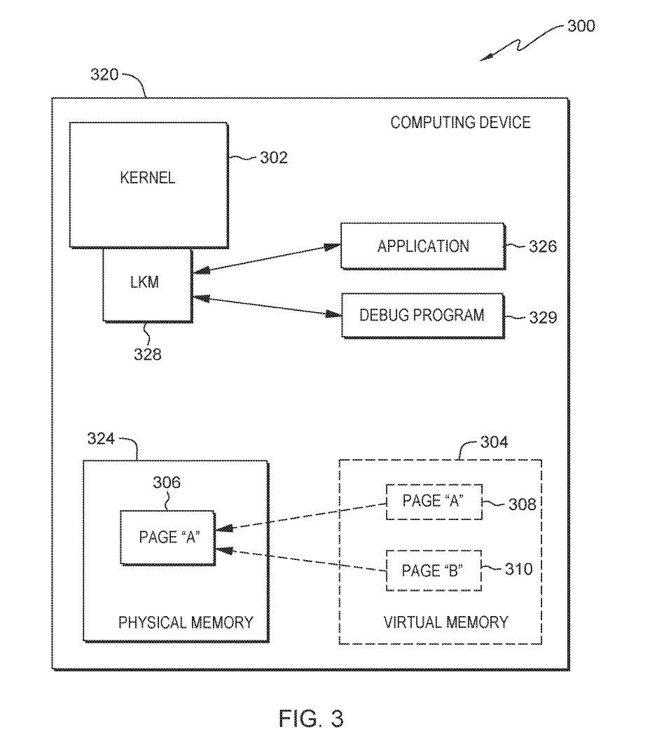

In an embodiment, debug program 129 receives an indication (step 202). In other words, debug program 129 receives an indication that debug program 129 has been opened on a computing device. Debug program 129 receives a second indication that debug program 129 has detected the presence of LKM 128. In an embodiment, debug program 129 and LKM 128 may be on the same computing device. In another embodiment, debug program 129 and LKM 128 may be on different computing devices. In an embodiment, a user activates debug program 129 on computing device 120 where application 126 has a memory corruption. Debug program 129 also receives an indication that LKM 128 is also found on computing device 120. For example, as shown in computing environment 300 in FIG. 3, debug program 329 (which is representative of debug program 129 in FIG. 1) has been opened on computing device 320 (which is representative of computing device 120 in FIG. 1). Application 326 (which is representative of application 126 in FIG. 1) is found on computing device 320. Application 326 is known to have a memory corruption based on preliminary debug efforts by the user of application 326 (i.e., application 326 is not running correctly, the user of application 326 has attempted to determine the cause of the problem, and the user has determined that application 326 has a static memory corruption). Debug program 329 has also determined that LKM 328 (which is representative of LKM 128 in FIG. 1) is found on computing device 320, extending the functionality of kernel 302. Physical memory 324 (which is representative of physical memory 124 in FIG. 1) is also on computing device 320.

In an embodiment, debug program 129 receives input (step 204). In other words, debug program 129 receives input, from a user, of a virtual memory address that requires monitoring. Debug program 129 also receives input, from the user, including a set of rules defining operations that are allowed (i.e., legal) and operations that are not allowed (i.e., illegal) for execution in the application with the static memory corruption. In an embodiment, the physical memory address that requires monitoring is known based on initial debugging. In another embodiment, the physical memory address that requires monitoring is unknown and is determined by running the application with the memory corruption. In an embodiment, a legal operation is writing to a page in memory except for the first twenty bytes of the page in memory and an illegal operation is writing to those first twenty bytes of the page in memory. In another embodiment, a legal operation is writing a specific value or data type to the first four bytes of a particular virtual memory address and an illegal operation is writing a value or data type, other than the specific value or data type, to those first four bytes of the particular virtual memory address. In an embodiment, a user inputs, via a user interface (not shown), the virtual memory address location to be monitored, to debug program 129. In an embodiment, the user also inputs, via debug program 129, the set of rules defining the legal and illegal operations executed by application 126. In an embodiment, both the virtual memory address to be monitored and the rules are passed by debug program 129 to LKM 128. For example, referring to computing environment 300 in FIG. 3, a user inputs to debug program 329 that the first twenty bytes of page “A” 308, in virtual memory 304, are to be monitored. The user also inputs to debug program 329 that writing to the first twenty bytes of page “A” 308, in virtual memory 304, is an illegal operation but writing to the balance of page “A” 308, in virtual memory 304, is a legal operation. Debug program 329 passes the virtual memory address and the rules to LKM 328.

In an embodiment, debug program 129 executes commands (step 206). In other words, debug program 129 executes a command that requests a loadable kernel module to change the access of a first page in virtual memory from “read/write” to “read” only and to create a second page, with “read/write” access, in virtual memory. In an embodiment, a first page in virtual memory and a second page in virtual memory are both mapped to a first page in physical memory. The creation of the first page in virtual memory is part of the execution of application 126. The result of the mapping is that the same content is stored to the first page in physical memory and both the first page in virtual memory and the second page in virtual memory. In an embodiment, debug program 129 requests LKM 128 to change the access of a first page found in virtual memory (not shown) from “read/write” access to “read” only. In the embodiment, debug program 129 also requests LKM 128 to create a second page found in virtual memory (not shown) with “read/write access. For example, referring to computing environment 300 in FIG. 3, debug program 329 requests LKM 328 to change the access of page “A” 308 in virtual memory 304 from “read/write” to “read” only. Also, debug program 329 requests that LKM 328 create page “B” 310, with “read/write” access, in virtual memory 304. Both page “A” 308 and page “B” 310 are mapped to page “A” 306 (in physical memory 324) so that all three pages include the same content.

In an embodiment, debug program 129 executes an application (step 208). In other words, debug program 129 executes the application that includes the static memory corruption. The application with the static memory corruption is executed so that debug program 129, through LKM 128, can monitor the area of concern in virtual memory that was specified in step 204. LKM 128 monitors the area of concern, as part of the debug process, watching for a page fault followed by an illegal operation. In an embodiment, debug program 129 executes application 126 on computing device 120 and monitors an area of virtual memory (not shown) via LKM 128 for a page fault followed by an illegal operation. For example, referring to computing environment 300 in FIG. 3, debug program 329 executes application 326 on computing device 320 and monitors the first twenty bytes on page “A” 308 in virtual memory 304 via LKM 328 for a page fault followed by an illegal operation.

In an embodiment, debug program 129 determines whether a page fault has occurred (decision step 210). In other words, debug program 129 determines whether a page fault has occurred in the application with the static memory corruption that is executing. In an embodiment, a page fault is a type of interrupt, called a trap, raised by computer hardware when a running program accesses a memory page that is mapped into the virtual address space, but not loaded into main memory. When handling a page fault, the operating system generally tries to make the required page accessible at the location in physical memory, or terminates the program in case of an illegal memory access. In an embodiment (decision step 210, NO branch), debug program 129 determines that a page fault has not occurred; therefore, debug program 129 returns to step 208 to continue executing the application. In the embodiment (decision step 210, YES branch), debug program 129 determines that a page fault has occurred; therefore, debug program 129 proceeds to decision step 212.

In an embodiment, debug program 129 determines whether a rule was broken (decision step 212). In other words, responsive to determining that a page fault has occurred (decision step 210, YES branch), debug program 129 determines whether a pre-defined rule has been broken. In an embodiment, the pre-defined rules are determined by a user and input to LKM 128 via debug program 129. In an embodiment, examples of rules that may be broken include writing to the first twenty bytes of page “A” 308 in virtual memory 304. In an embodiment, LKM 128 will determine whether the current process executing is part of application 126 and will monitor the first twenty bytes of page “A” 308, in virtual memory 304, for a write access attempt. In an embodiment, debug program 129 determines that a rule has not been broken (decision step 212, NO branch); therefore, debug program 129 returns to step 208 to continue executing the application. In the embodiment (decision step 212, YES branch), debug program 129 determines that a rule has been broken; therefore, debug program 129 proceeds to step 214.

In an embodiment, debug program 129 stops the application (step 214). In other words, responsive to determining that a page fault has occurred (decision step 210, YES branch) and that a rule has been broken (decision step 212, YES branch), debug program 129 stops the execution of the application with the static memory corruption. In an embodiment, debug program 129 stops the execution of the application with the static memory corruption. In another embodiment, the OS stops the execution of the application with the static memory corruption. In an embodiment, debug program 129 stops the execution of application 126. For example, referring to computing environment 300 in FIG. 3, debug program 329 stops the execution of application 326.

In an embodiment, debug program 129 records data (step 216). In other words, debug program 129, in response to the rule being broken (decision step 212, YES branch) and the application execution being stopped (step 214), records data pertaining to the state of the application at the point in time that the application was stopped. In an embodiment, examples of data that may be recorded include which step in the application was writing data to the virtual memory address being monitored, a value of the data being written, and a current call stack for the application. In an embodiment, the recorded data may be sent to a user of debug program 129 so that the user may debug the static memory corruption in the application. In another embodiment, a notification may be sent to a user that the execution of the application has stopped and recorded data is available for the user. In an embodiment, a user of debug program 129 may be able to use the recorded data, captured by LKM 128 and debug program 129, to debug the static memory corruption in application 126. For example, referring to computing environment 300 in FIG. 3, a user of debug program 329 may be able to use the recorded data, captured by LKM 328 and debug program 329, to debug the static memory corruption in application 326.

According to an embodiment of the present invention, a master computing device (not shown) may be used to monitor a plurality of computing device 120 interconnected over network 110, all of which include application 126 with a static memory corruption, LKM 128 and debug program 129. In the embodiment, the master computing device controls the overall debugging process of application 126 by communicating with each debug program 129 in the plurality of computing device 120. Also in the embodiment, the rules are defined via debug program 129 included on the master computing device and the rules are broadcast to the plurality of computing device 120. Each LKM 128 monitors for a broken rule and captures data when a rule is broken. The captured data is returned to the master computing device to complete the debugging process.

FIG. 4 depicts computer system 400, which is an example of a system that includes debug program 129. Computer system 400 includes processors 401, cache 403, memory 402, persistent storage 405, communications unit 407, input/output (I/O) interface(s) 406 and communications fabric 404. Communications fabric 404 provides communications between cache 403, memory 402, persistent storage 405, communications unit 407, and input/output (I/O) interface(s) 406. Communications fabric 404 can be implemented with any architecture designed for passing data and/or control information between processors (such as microprocessors, communications and network processors, etc.), system memory, peripheral devices, and any other hardware components within a system. For example, communications fabric 404 can be implemented with one or more buses or a crossbar switch.

Memory 402 and persistent storage 405 are computer readable storage media. In this embodiment, memory 402 includes random access memory (RAM). In general, memory 402 can include any suitable volatile or non-volatile computer readable storage media. Cache 403 is a fast memory that enhances the performance of processors 401 by holding recently accessed data, and data near recently accessed data, from memory 402.

Program instructions and data used to practice embodiments of the present invention may be stored in persistent storage 405 and in memory 402 for execution by one or more of the respective processors 401 via cache 403. In an embodiment, persistent storage 405 includes a magnetic hard disk drive. Alternatively, or in addition to a magnetic hard disk drive, persistent storage 405 can include a solid state hard drive, a semiconductor storage device, read-only memory (ROM), erasable programmable read-only memory (EPROM), flash memory, or any other computer readable storage media that is capable of storing program instructions or digital information.

The media used by persistent storage 405 may also be removable. For example, a removable hard drive may be used for persistent storage 405. Other examples include optical and magnetic disks, thumb drives, and smart cards that are inserted into a drive for transfer onto another computer readable storage medium that is also part of persistent storage 405.

Communications unit 407, in these examples, provides for communications with other data processing systems or devices. In these examples, communications unit 407 includes one or more network interface cards. Communications unit 407 may provide communications through the use of either or both physical and wireless communications links. Program instructions and data used to practice embodiments of the present invention may be downloaded to persistent storage 405 through communications unit 407.

I/O interface(s) 406 allows for input and output of data with other devices that may be connected to each computer system. For example, I/O interface 406 may provide a connection to external devices 408 such as a keyboard, keypad, a touch screen, and/or some other suitable input device. External devices 408 can also include portable computer readable storage media such as, for example, thumb drives, portable optical or magnetic disks, and memory cards. Software and data used to practice embodiments of the present invention can be stored on such portable computer readable storage media and can be loaded onto persistent storage 405 via I/O interface(s) 406. I/O interface(s) 406 also connect to display 409.

Display 409 provides a mechanism to display data to a user and may be, for example, a computer monitor.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

What is claimed is:

1. A method for debugging a static memory corruption, the method comprising the steps of:
receiving, by one or more computer processors, an indication of an address in a first page in virtual memory used by an application with a static memory corruption, wherein the address in the first page in virtual memory will be monitored by a loadable kernel module;
changing, by one or more computer processors, an access to the first page in virtual memory from read/write access to read only access;
creating, by one or more computer processors, a second page in virtual memory with read/write access; and
determining, by one or more computer processors, whether a page fault occurs on the first page in virtual memory during an execution of the application with the static memory corruption.

2. The method of claim 1, further comprising:
receiving, by one or more computer processors, a set of rules defining legal operations during the execution of the application with a static memory corruption and a set of rules defining illegal operations during the execution of the application with a static memory corruption;
responsive to determining that a page fault has occurred on the first page in virtual memory, determining, by one or more computer processors, whether a rule in the set of rules defining illegal operations during the execution of the application with a static memory corruption has been broken based on the page fault; and
responsive to determining that a rule in the set of rules defining illegal operations during the execution of the application with a static memory corruption has been broken, stopping, by one or more computer programs, the execution of the application with the static memory corruption.

3. The method of claim 2, further comprising:
responsive to determining that a rule in the set of rules defining illegal operations during the execution of the application with a static memory corruption has not been broken, continuing, by one or more computer programs, the execution of the application with the static memory corruption.

4. The method of claim 2, further comprising:
responsive to stopping the execution of the application with the static memory corruption, recording, by one or more computer processors, a set of data at a point in time when the application with the static memory corruption was stopped, wherein the set of data is selected from a group consisting of which step in the application with the static memory corruption was writing to the monitored virtual memory address, a value of the data being written, and a current call stack for the application with the static memory corruption, and wherein the set of data is used to debug the static memory corruption in the application with the static memory corruption.

5. The method of claim 1, wherein the first page in virtual memory and the second page in virtual memory are mapped to a same page in physical memory and wherein a same content is stored to the first page in virtual memory, the second page in virtual memory and the page in physical memory.

6. The method of claim 1, wherein the application with the static memory corruption is found on a plurality of computing devices and wherein the debugging of the application with the static memory corruption on the plurality of computing devices is controlled by a single computing device of the plurality of computing devices.

7. The method of claim 1, wherein the loadable kernel module is an object file that contains code to extend a running kernel of an operating system included on a computing device.

8. A computer program product for debugging a static memory corruption, the computer program product comprising:
one or more computer readable storage media; and
program instructions stored on the one or more computer readable storage media, the program instructions comprising:
program instructions to receive an indication of an address in a first page in virtual memory used by an application with a static memory corruption, wherein the address in the first page in virtual memory will be monitored by a loadable kernel module;
program instructions to change an access to the first page in virtual memory from read/write access to read only access;
program instructions to create a second page in virtual memory with read/write access; and
program instructions to determine whether a page fault occurs on the first page in virtual memory during an execution of the application with the static memory corruption.

9. The computer program product of claim 8, further comprising program instructions, stored on the one or more computer readable storage media, to:
receive a set of rules defining legal operations during the execution of the application with a static memory corruption and a set of rules defining illegal operations during the execution of the application with a static memory corruption;
responsive to determining that a page fault has occurred on the first page in virtual memory, determine whether a rule in the set of rules defining illegal operations during the execution of the application with a static memory corruption has been broken based on the page fault; and
responsive to determining that a rule in the set of rules defining illegal operations during the execution of the application with a static memory corruption has been broken, stop the execution of the application with the static memory corruption.

10. The computer program product of claim 9, further comprising program instructions, stored on the one or more computer readable storage media, to:
responsive to determining that a rule in the set of rules defining illegal operations during the execution of the application with a static memory corruption has not been broken, continue the execution of the application with the static memory corruption.

11. The computer program product of claim 9, further comprising program instructions, stored on the one or more computer readable storage media, to:
responsive to stopping the execution of the application with the static memory corruption, record a set of data at a point in time when the application with the static memory corruption was stopped, wherein the set of data is selected from a group consisting of which step in the application with the static memory corruption was writing to the monitored virtual memory address, a value of the data being written, and a current call stack for the application with the static memory corruption, and wherein the set of data is used to debug the static memory corruption in the application with the static memory corruption.

12. The computer program product of claim 8, wherein the first page in virtual memory and the second page in virtual memory are mapped to a same page in physical memory and wherein a same content is stored to the first page in virtual memory, the second page in virtual memory and the page in physical memory.

13. The computer program product of claim 8, wherein the application with the static memory corruption is found on a plurality of computing devices and wherein the debugging of the application with the static memory corruption on the plurality of computing devices is controlled by a single computing device of the plurality of computing devices.

14. The computer program product of claim 8, wherein the loadable kernel module is an object file that contains code to extend a running kernel of an operating system included on a computing device.

15. A computer system for debugging a static memory corruption, the computer system comprising:
one or more computer processors;
one or more computer readable storage media; and
program instructions stored on the one or more computer readable storage media for execution by at least one of the one or more computer processors, the program instructions comprising:
program instructions to receive an indication of an address in a first page in virtual memory used by an application with a static memory corruption, wherein the address in the first page in virtual memory will be monitored by a loadable kernel module;
program instructions to change an access to the first page in virtual memory from read/write access to read only access;
program instructions to create a second page in virtual memory with read/write access; and
program instructions to determine whether a page fault occurs on the first page in virtual memory during an execution of the application with the static memory corruption.

16. The computer system of claim 15, further comprising program instructions stored on the one or more computer readable storage media for execution by at least one of the one or more computer processors, to:
receive a set of rules defining legal operations during the execution of the application with a static memory corruption and a set of rules defining illegal operations during the execution of the application with a static memory corruption;
responsive to determining that a page fault has occurred on the first page in virtual memory, determine whether a rule in the set of rules defining illegal operations during the execution of the application with a static memory corruption has been broken based on the page fault; and
responsive to determining that a rule in the set of rules defining illegal operations during the execution of the application with a static memory corruption has been broken, stop the execution of the application with the static memory corruption.

17. The computer system of claim 16, further comprising program instructions stored on the one or more computer readable storage media for execution by at least one of the one or more computer processors, to:
responsive to determining that a rule in the set of rules defining illegal operations during the execution of the application with a static memory corruption has not been broken, continue the execution of the application with the static memory corruption.

18. The computer system of claim 16, further comprising program instructions stored on the one or more computer readable storage media for execution by at least one of the one or more computer processors, to:
responsive to stopping the execution of the application with the static memory corruption, record a set of data at a point in time when the application with the static memory corruption was stopped, wherein the set of data is selected from a group consisting of which step in the application with the static memory corruption was writing to the monitored virtual memory address, a value of the data being written, and a current call stack for the application with the static memory corruption, and wherein the set of data is used to debug the static memory corruption in the application with the static memory corruption.

19. The computer system of claim 15, wherein the first page in virtual memory and the second page in virtual memory are mapped to a same page in physical memory and wherein a same content is stored to the first page in virtual memory, the second page in virtual memory and the page in physical memory.

20. The computer system of claim 15, wherein the application with the static memory corruption is found on a plurality of computing devices and wherein the debugging of the application with the static memory corruption on the plurality of computing devices is controlled by a single computing device of the plurality of computing devices.
